(19) United States
(12) Patent Application Publication
(10) Pub. No.: US 2018/0236417 A1
(43) Pub. Date: Aug. 23, 2018

(54) LIQUID INLINE MIXING AND GAS INFUSION SYSTEM

(71) Applicant: Joyride Coffee Distributors, LLC, Woodside, NY (US)

(72) Inventor: Zachary Allen Wilburn Borders, San Francisco, CA (US)

(21) Appl. No.: 15/897,709

(22) Filed: Feb. 15, 2018

Related U.S. Application Data
(60) Provisional application No. 62/461,144, filed on Feb. 20, 2017.

(51) Int. Cl. B01F 3/04; A23L 2/54; B01F 15/02; B01F 15/00; B01F 3/08; B67D 1/00

(52) U.S. Cl. CPC B01F 3/04815; A23L 2/54; B01F 15/0261; B01F 15/00422; B01F 3/0861; B01F 2215/0022; B67D 1/0069; A23V 2002/00; B01F 2003/049; B01F 2003/04921; B01F 15/0243

(57) ABSTRACT

A beverage dispensing system includes an infusion unit and a dispensing station. The infusion unit is to mix a liquid beverage product and a gas to produce a gas-infused liquid beverage product. The infusion unit includes a first infusion unit inlet to receive the liquid beverage product, a second infusion unit inlet to receive the gas, and a first infusion unit outlet to output the gas-infused liquid beverage product. The dispensing station includes a first valve, coupled to the first outlet of the infusion unit, to receive and dispense the gas-infused liquid beverage product. The dispensing station further includes a second valve to receive and dispense the liquid beverage product.

### CROSS-REFERENCE TO RELATED APPLICATION

This application claims the benefit of U.S. Provisional Application No. 62/461,144, filed on Feb. 20, 2017, the contents of which are incorporated by reference herein.

### BACKGROUND

Beverage dispensing systems dispense liquid beverage products for consumption. A beverage dispensing system may combine one or more liquids and one or more gases to produce a liquid beverage product. The rate of combination and manner of combination of the one or more liquids and the one or more gases affect the resulting liquid beverage product.

### BRIEF DESCRIPTION OF DRAWINGS

The examples described herein will be understood more fully from the detailed description given below and from the accompanying drawings, which, however, should not be taken to limit the application to the specific examples, but are for explanation and understanding only.

FIG. 1A is a schematic diagram illustrating a beverage dispensing system, according to one embodiment.

FIG. 1B is a schematic diagram illustrating a beverage dispensing system, according to another embodiment.

FIG. 1C is a schematic diagram illustrating a beverage dispensing system, according to another embodiment.

FIGS. 2A-B illustrate an infusion unit of the beverage dispensing system, according to one embodiment.

FIG. 3 illustrates an exploded view of an infusion unit of the beverage dispensing system, according to one embodiment.

FIGS. 4A-I illustrate assembling an infusion unit of the beverage dispensing system, according to one embodiment.

FIG. 5A illustrates an assembled view of an infusion unit of the beverage dispensing system, according to one embodiment.

FIG. 5B illustrates an assembled view of an infusion unit of the beverage dispensing system, according to another embodiment.

FIG. 6 is a flow diagram of one embodiment of a method of dispensing a liquid via a beverage dispensing system, in accordance with embodiments of the present disclosure.

FIG. 7 is a flow diagram of one embodiment of a method of dispensing a liquid via a beverage dispensing system, in accordance with embodiments of the present disclosure.

FIG. 8 illustrates a component diagram of a computer system which may implement one or more methods of dispensing a liquid via a beverage dispensing system described herein.

### DETAILED DESCRIPTION

Beverage dispensing systems combine one or more liquids and one or more gases to produce a liquid beverage product for consumption. For example, a beverage dispensing system may combine coffee with gas to produce a coffee with gas (e.g., nitro coffee, etc.).

A conventional system includes a vessel (e.g., keg) of cold brew coffee, a tank containing nitrogen at a high pressure (e.g., 6.0 bar to 6.5 bar), and a discharging unit. The vessel may be coupled to both the tank and the discharge unit. The tank may pressurize the vessel with nitrogen so that the coffee in the vessel absorbs the nitrogen over time. The discharging unit may discharge the coffee that has absorbed nitrogen. The entire vessel of coffee is served as nitrogen-absorbed coffee and the level of nitrogen in the coffee is not adjustable. Nitrogen from the vessel may be wasted through venting.

Another conventional system includes a beverage supply, a pressurized gas supply, a liquid/gas contactor membrane unit, a diaphragm pump, and a beverage faucet. The liquid/gas contactor membrane unit includes hollow gas-permeable membranes arranged within a solid casing and surrounded by fluid space within the solid casing. The pressurized gas is passed through the hollow gas-permeable membranes and the beverage is passed through the fluid space. The pressurized gas seeps through the gas-permeable membranes into the beverage. The system requires an inline strainer and filtration unit because the beverage must be highly filtered to protect the gas-permeable membranes. The system dispenses only beverage that has absorbed gas via the gas-permeable membranes and only at one level of gas-absorption. The rates of gas-absorption are not adjustable by the user.

Yet another conventional system includes a water supply, a pressurized gas supply, a concentrated beverage supply, a liquid/gas contactor membrane unit, two diaphragm pumps, and a beverage faucet. The pressurized gas is passed through the hollow gas-permeable membranes of the liquid/gas contactor membrane unit and the water is passed through the fluid space in the liquid/gas contactor membrane unit. The pressurized gas seeps through the gas-permeable membranes into the water. The water that has absorbed the gas is combined with a highly (e.g., 8x) concentrated beverage and is dispensed via the beverage faucet. This system dispenses only beverage that is mixed with water that has absorbed the gas and only at one level of gas-absorption. This system does not work with read-to-drink beverages or a mid-to-low concentrated beverage product.

Aspects of the disclosure address the above-mentioned and other challenges by providing a beverage dispensing system that includes an infusion unit to infuse gas into a liquid beverage product. The infusion unit may receive a liquid beverage product (e.g., a ready-to-drink beverage) and gas. The infusion unit may include a diffusion stone (e.g., 2-micron diffusion stone, 0.5-micron diffusion stone, etc.) to receive the gas and to infuse the gas into the liquid beverage product. The infusion unit may output a gas-infused liquid beverage product. The beverage dispensing system may further include a dispensing station to dispense the gas-infused liquid beverage product and the liquid beverage product (i.e., still liquid beverage product). The dispensing station may further dispense water and concentrated liquid beverage product. Each user may control the level of gas-infusion of the gas-infused liquid beverage product. The liquid beverage product may be infused with gas on-demand (e.g., produced in-line instead of producing a keg of gas-infused liquid beverage product). Since the beverage dispensing system uses an infusion unit, high levels of filtration of the liquid beverage product are not needed (e.g., as compared to using a liquid/gas contactor membrane unit). Since the infusion unit receives liquid beverage product (e.g., ready-to-drink beverage), the beverage dispensing system can use any level of concentration of liquid beverage product (e.g., non-concentrated, low-concentrated, mid-concentrated, highly-concentrated, etc.).

The systems and methods described herein utilize one or more liquid beverage products. A liquid beverage product may be a ready-to-drink beverage. The liquid beverage product may be temperature regulated (e.g., chilled, heated, served at room temperature) prior to being dispensed. A liquid beverage product may not be infused with gas. A liquid beverage product may include one or more of water, coffee, tea, roasted-grain beverage, juice, electrolyte drink, etc. Coffee may include one or more of cold-brew coffee (e.g., steeping ground beans in cold water for several hours and then filtering), coffee brewed by boiling, coffee brewed using gravity (e.g., via coffee percolator, via an automatic coffeemaker), coffee brewed by steeping (e.g., via a French press, cafetiere, coffee press, coffee plunger), etc.

The systems and methods described herein utilize one or more gases. For example, a gas may include one or more of carbon dioxide (CO₂), nitrogen (N₂), nitrous oxide (N₂O), etc.

A gas-infused liquid beverage product may be a ready-to-drink beverage that is infused with one or more types of gas. The gas-infused liquid beverage product may be temperature regulated (e.g., chilled, heated, served at room temperature) prior to being dispensed. A gas-infused liquid beverage product may include one or more of cold brew coffee infused with nitrogen (e.g., nitro cold brew coffee (NCB), nitro coffee), cold brew coffee infused with CO₂, coffee infused with a combination of nitrogen and CO₂ (e.g., 75% nitrogen and 25% CO₂), tea infused with nitrogen (e.g., nitro tea), juice infused with nitrogen, etc.

When gas infused, the liquid beverage product may have a striking appearance, enhanced aromatic presence, a distinct tasting experience enriched by a foam texture amplifying the mouthfeel (physical sensations in the mouth caused by the liquid beverage product, as distinct from taste) and flavor notes. A gas-infused liquid beverage product may have a creamy head. The head may be longer-lasting than a non-gas-infused liquid beverage product. Infusion of nitrogen may extract sweet flavors and a smooth finish from a liquid beverage product, making it harder for the water in the liquid beverage product to dissolve and resulting in a liquid beverage product with a thicker mouthfeel.

The systems and methods described herein may utilize one or more concentrated liquid beverage products. A concentrated liquid beverage product may be a beverage in a high ingredient content form which is to be diluted with water to a level appropriate for consumption. For example, a concentrated liquid beverage product may include one or more of flavored syrup, syrup concentrate, brewed coffee concentrate, tea concentrate, bag-in-box beverage concentrate, etc.

The systems and methods described herein use components that may be fluidly coupled. Fluidly coupled may be refer to conveying fluids (e.g., liquids, gases) from one location to another. Fluid coupling between components may be via lines (e.g., supply lines, transfer lines, gas lines, water lines, beverage lines, etc.). Lines may refer to tubing, piping, etc. One or more in-line components (e.g., fittings, valves, etc.) may be included in the lines.

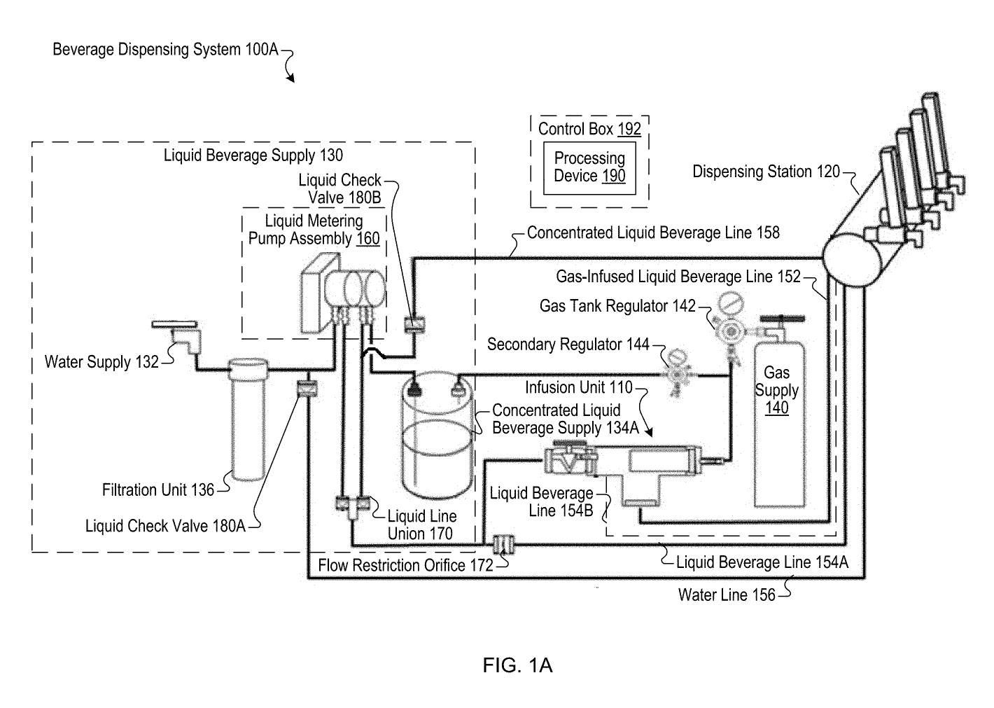

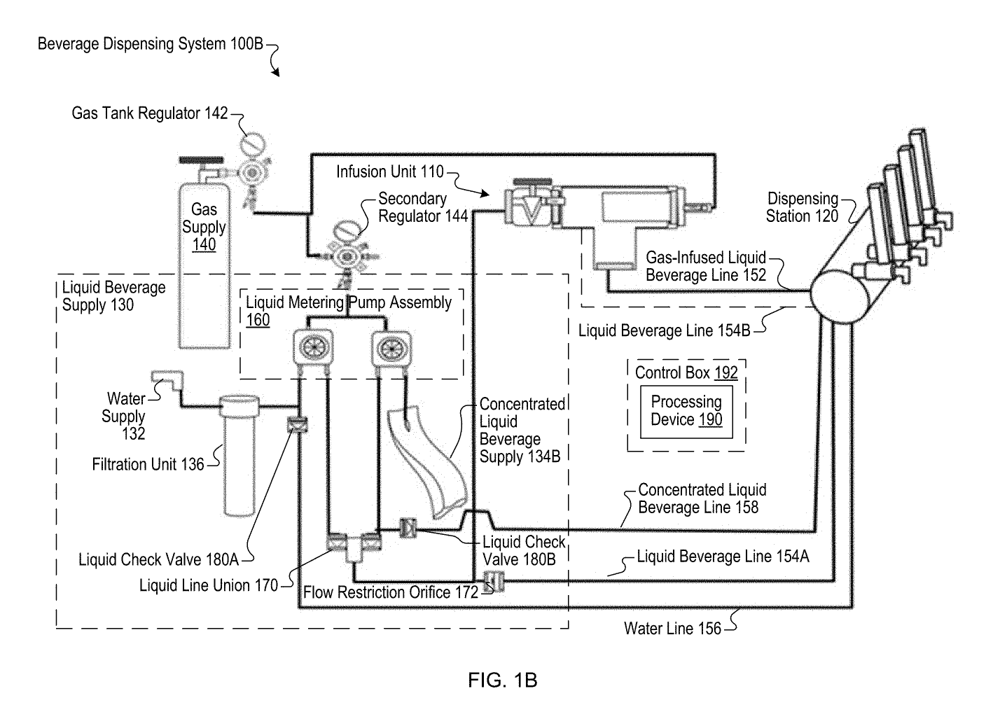

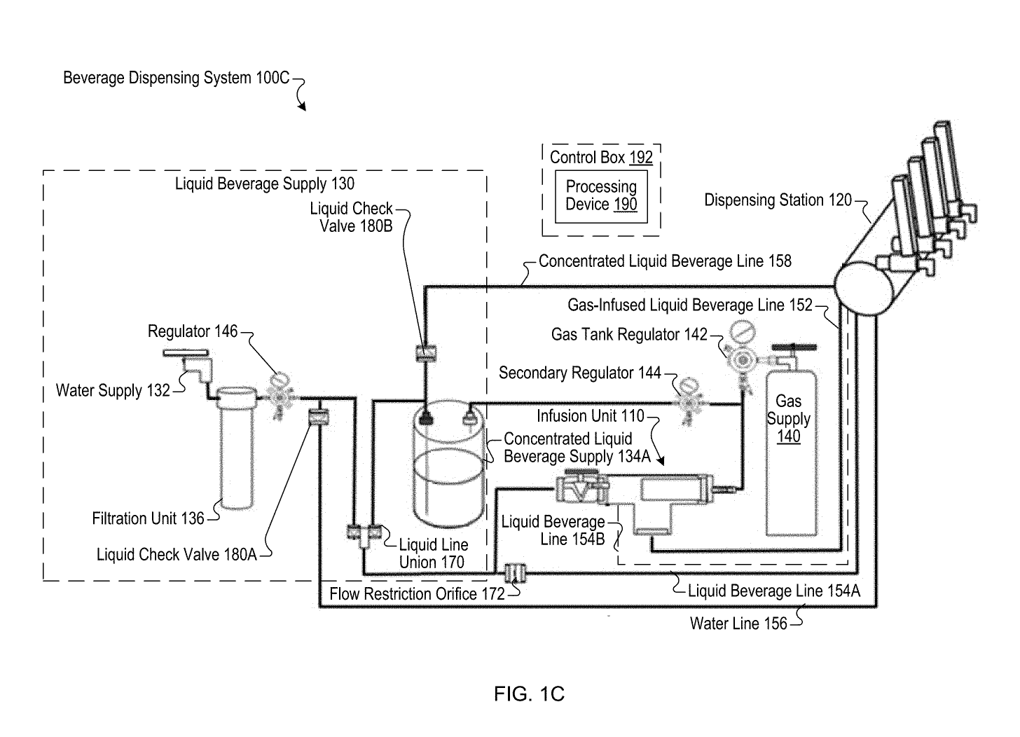

FIGS. 1A-C are schematic diagrams illustrating a beverage dispensing system 100, according to embodiments. In some embodiments, the beverage dispensing system 100 is a processing unit for packaging a beverage (e.g., a gas-infused liquid beverage product). In some embodiments, the beverage dispensing system 100 is a self-contained dispensing unit. The beverage dispensing system 100 may be configured to dispense a plurality of beverages including two or more of filtered water, a concentrated liquid beverage product, a non-concentrated liquid beverage product, a mix derived from a metered concentrated liquid beverage product and filtered water, and a gas-infused (by one or more types of gases) infused liquid beverage product. The beverage dispensing system 100 may transfer liquids, mix transferred liquids, and infuse gases with liquids substantially instantaneously when dispensing station 120 is activated (e.g., one or more valves of the dispensing station are opened). Parameters of the beverage dispensing system 100 may be adjusted to provide varying amounts of gas, liquids, and rates of infusion. The rate the liquid is dispensed and at which gas is infused into the liquid may be controlled by one or more aspects of the beverage dispensing system 100.

The beverage dispensing system 100 includes an infusion unit 110 and a dispensing station 120. In some embodiments, the beverage dispensing system 100 is coupled to a liquid beverage supply 130 and a gas supply 140. In some embodiments, the beverage dispensing system 100 includes the liquid beverage supply 130 and the gas supply 140. The gas supply 140 may be tank or canister that stores gas under pressure (e.g., a pressurized cylinder). Compressed gas may be delivered into the beverage dispensing system 100 from the gas supply 140 (e.g., as regulated by the gas tank regulator 142).

The infusion unit 110 is fluidly coupled to the liquid beverage supply 130 and the gas supply 140. The dispensing station 120 is fluidly coupled to the infusion unit 110 via a gas-infused liquid beverage line 152 to dispense a gas-infused liquid beverage product. In some embodiments, the dispensing station 120 is fluidly coupled to the liquid beverage supply 130 via a liquid beverage line 154A to dispense a liquid beverage product. In some embodiments, the dispensing station 120 is fluidly coupled to the infusion unit 110 via a liquid beverage line 154B to dispense a liquid beverage product.

In some embodiments, the liquid beverage supply 130 may include a liquid metering pump assembly 160 fluidly coupled to the infusion unit 110 to cause the liquid beverage product to flow into the infusion unit 110. The liquid beverage supply 130 may further include a water supply 132 (e.g., an external source), a concentrated liquid beverage supply 134, and a liquid line union 170.

The concentrated liquid beverage product and the filtered water may be pressurized by liquid metering pump assembly 160 creating a positive pressure environment (e.g., concentrated liquid beverage product may be transferred from the concentrated liquid beverage supply 134 and water may be transferred from the water supply 132 responsive to a vacuum created by operation of the liquid metering pump assembly 160). Relief of pressure by the dispensing station 120 (e.g., opening of a valve of the dispensing station 120 to dispense liquid) may create flow from the pressurized liquid lines (e.g., all four of gas-infused liquid beverage line 152, liquid beverage line 154, water line 156, and concentrated liquid beverage line 158).

In some embodiments, the liquid metering pump assembly 160 has a first portion 162A fluidly coupled to a water supply 132 to receive water and a second portion 162B fluidly coupled to a concentrated liquid beverage supply 134 to receive concentrated liquid beverage product. In some embodiments, the first portion 162A and the second portion 162B are integrated into one component. In some embodiments, the first portion 162A is a first pump and the second portion 162B is a second pump. In some embodiments, the processing device 190 controls the first portion 162A and the second portion 162B independent of each other. The liquid metering pump assembly 160 may include a dual head liquid metering pump or multiple liquid metering pumps. In some embodiments, the liquid metering pump assembly 160 pumps fluids responsive to receiving power provided by an electrical source. In some embodiments, the liquid metering pump assembly 160 pumps fluids responsive to receiving gas pressure. In some embodiments, the liquid metering pump assembly 160 pumps fluids responsive to a lack of gas pressure.

The water may be provided by an external source (e.g., water supply 132), routed through a filtration unit 136, and delivered to liquid metering pump assembly 160 by means of a vacuum created by pump operation of the liquid metering pump assembly 160. Water may be routed through the filtration unit 136 under self-provided pressure of the water supply 132 responsive to opening of the valve of the dispensing station 120 coupled to the water line 156.

The liquid metering pump assembly 160 may be fluidly coupled to a liquid line union 170. Liquid line union 170 may be a housing that includes a conjunction of orifices and attached check valves and may mix concentrated liquid beverage product and water received from liquid metering pump assembly 160. The first portion 162A may output the water under pressure to a first inlet (e.g., first entry orifice, first union inlet) of the liquid line union 170 and the second portion 162B may output the concentrated liquid beverage to a second inlet (e.g., second entry orifice, second union inlet) of the liquid line union 170. Check valves may be attached to the first inlet and the second inlet of the liquid line union 170 to provide a barrier between possible differing line pressures. The liquid line union 170 may mix the water and the concentrated liquid beverage to output a liquid beverage product (e.g., ready-to-drink liquid beverage product) via a conjunction port (e.g., union outlet) of the liquid line union 170 subsequent to the mixing. The liquid beverage product exiting the liquid line union 170 has been pressurized via the liquid metering pump assembly 160 (e.g., via the water and concentrated liquid beverage product being pressurized) and creates a positive pressure environment to be dispensed or to be infused with gas and then dispensed. The liquid line union 170 may be fluidly coupled to the infusion unit 110 to provide the liquid beverage product under pressure to the infusion unit 110. In some embodiments, the liquid line union 170 is fluidly coupled to the dispensing station 120 to provide the liquid beverage product under pressure to the dispensing station 120 via liquid beverage line 154A.

In some embodiments, the liquid metering pump assembly 160 may pump the liquid beverage product to the infusion unit 110 and/or the dispensing station 120.

The dispensing station 120 may be fluidly coupled with the water supply 132 via a water line 156 to dispense water. The filtration unit 136 may be fluidly coupled with the water supply 132 to filter the water (e.g., before entering the liquid metering pump assembly 160, before entering the dispensing station 120).

The gas supply 140 may be fluidly coupled with a gas tank regulator 142 to regulate the pressure of the gas (e.g., before entering the infusion unit 110). In some embodiments, the gas supply 140 is fluidly coupled with the concentrated liquid beverage supply 134 to provide gas to the concentrated liquid beverage supply 134.

In some embodiments, as illustrated in FIG. 1A, the concentrated liquid beverage supply 134A may include concentrated liquid beverage product encapsulated by a sealed container. The sealed container may have a hard structural casing (e.g., cornelius keg, a metal canister, etc.) incapable of tolerating negative pressure environment without damage or failure. In some embodiments, a secondary regulator 144 may be disposed downstream from the gas tank regulator 142 and may provide gas to the concentrated liquid beverage supply 134 (e.g., to relieve the negative pressure, to avoid having negative pressure). The secondary regulator 144 may allow enough gas to enter the concentrated liquid beverage supply to avoid a negative pressure in the concentrated liquid beverage supply without infusing gas into the concentrated liquid beverage. In some embodiments, the beverage dispensing system 100A may not have a secondary regulator 144 responsive to the container that stores the concentrated liquid beverage supply 134 having a vacuum relief (e.g., vacuum relief valve, vacuum relief system).

As illustrated in FIG. 1B, the concentrated liquid beverage supply 134B may include concentrated liquid beverage product within a flexible material (e.g., within bag-in-box, within a bag-like package). The beverage dispensing system 100B may not include a gas line from the gas supply 140 to the concentrated liquid beverage supply 134B responsive to the concentrated liquid beverage supply 134 being within a flexible material. The beverage dispensing system 100B may not include a secondary regulator 144 responsive to the concentrated liquid beverage supply 134 being within a flexible material.

Returning to FIGS. 1A-C, the beverage dispensing system 100 may include one or more liquid check valves 180. In some embodiments, a liquid check valve 180A is disposed between the filtration unit 136 and the dispensing station 120 so that water can flow from the filtration unit 136 to the dispensing station 120, but water cannot flow from the dispensing station 120 back to the filtration unit 136. In some embodiments, a liquid check valve 180B is disposed between the liquid metering pump assembly 160 and the dispensing station 120 to allow concentrated liquid beverage product to flow from the liquid metering pump assembly 160 to the dispensing station 120 without allowing concentrated liquid beverage product to flow from the dispensing station 120 to the liquid metering pump assembly 160. A flow restriction orifice 172 may be disposed between the liquid line union 170 and the dispensing station 120 to restrict the flow rate of the liquid beverage product between the liquid line union 170 and the dispensing station 120 without restricting the flow rate of the liquid beverage product between the liquid line union 170 and the infusion unit 110. The flow restriction orifice 172 may be adjustable to control the flow rate of the liquid beverage product between the liquid line union 170 and the dispensing station 120. In some embodiments, the flow restriction orifice 172 may be adjusted by the processing device 190.

The dispensing station 120 may include one or more valves. A first valve may be coupled to an outlet of the infusion unit 110 via the gas-infused liquid beverage line 152 to dispense gas-infused liquid beverage product. A second valve may be coupled to the outlet of the liquid line union 170 via liquid beverage line 154A to dispense liquid beverage product. A third valve may be coupled to the water supply 132 via water line 156 (e.g., and filtration unit 136 and liquid metering pump assembly 160) to output water. A fourth valve may be coupled to the concentrated liquid beverage supply 134 via concentrated liquid beverage line 158 (e.g., and liquid metering pump assembly 160) to output concentrated liquid beverage product. A fifth valve may be coupled to the infusion unit 110 (e.g., at a portion of the infusion unit before the liquid beverage product is infused with gas) via liquid beverage line 154B to output liquid beverage product.

In some embodiments, the dispensing station 120 may dispense concentrated liquid beverage product responsive to the liquid metering pump assembly 160 including twin liquid metering pumps. In some embodiments, the dispensing station 120 may dispense concentrated liquid beverage product responsive to the concentrate liquid beverage product being provided in hard encapsulation under pressure by a secondary regulator 144 with a dual-head liquid metering pump.

The liquids in gas-infused liquid beverage line 152, liquid beverage line(s) 154, water line 156, and concentrated liquid beverage line 158 may each be under pressure (e.g., at a pressure above atmospheric pressure). Opening of a valve of the dispensing station 120 exposes the liquid in the corresponding line to atmospheric pressure which causes the liquid to flow through the corresponding line and out the valve of the dispensing station 120, relieving pressure in the corresponding line. The water supply 132 may provide a constant pressure to the water in the water line 156. The gas supply 140 and gas tank regulator 142 may provide a constant supply of gas to the infusion unit 110. The liquid metering pump assembly 160 may sense a drop in pressure in one or more of the first portion 162A or the second portion 162B and may raise the pressure accordingly.

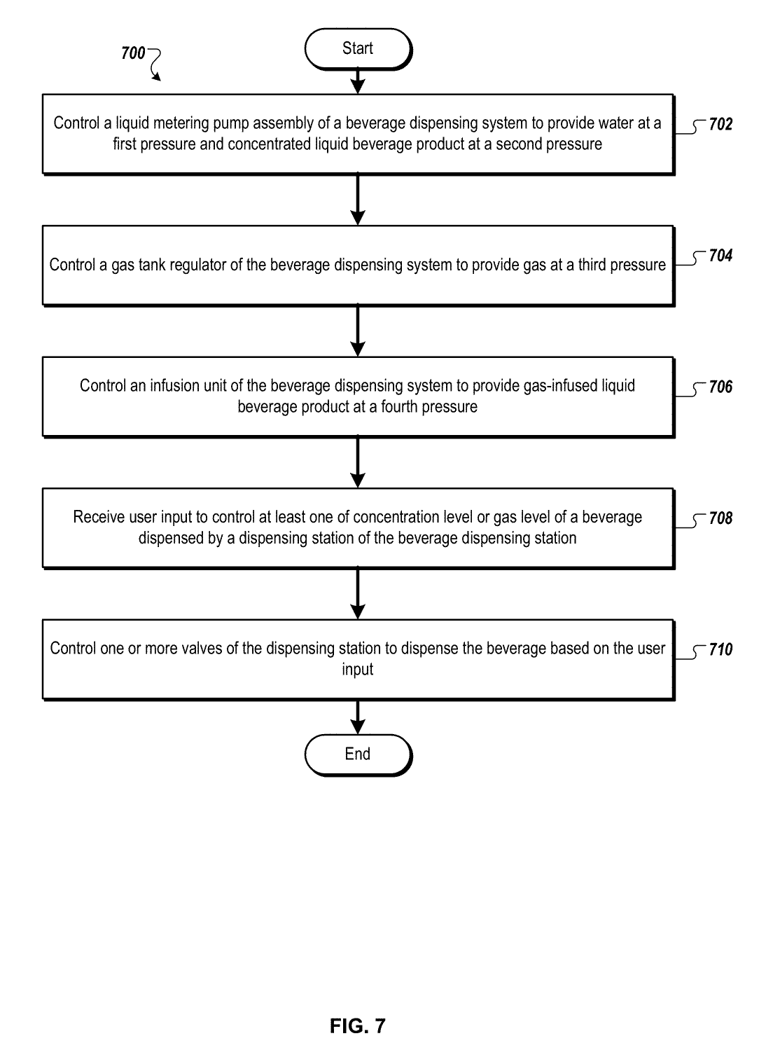

The beverage dispensing system 100 may include a processing device 190. The processing device 190 may be disposed within a control box 192. The processing device 190 may be coupled to one or more of the dispensing station 120, the gas tank regulator 142, the liquid metering pump assembly 160, the flow restriction orifice 172, etc. In some embodiments, the processing device 190 may be coupled to one or more of the gas tank regulator 142, the secondary regulator 144, or the regulator 146 (see FIG. 1C). The processing device 190 may be coupled to the valves of the dispensing station 120. The processing device 190 may be coupled to a user interface (e.g., integrated into the dispensing station 120, displayed on a computing device external to the dispensing station 120, etc.). The user interface may receive user input to control one or more of the amount of gas, the level of concentration, etc. of the liquid dispensed by the dispensing station 120. In response to the user interface receiving user input to change the gas level and/or concentration level, the processing device 190 may control one or more valves of the dispensing station 120 (see FIG. 7).

In some embodiments, as illustrated in FIG. 1C, the liquid beverage supply 130 may regulate the pressure of the liquids (e.g., water, concentrated liquid beverage product, liquid beverage product, etc.) by using regulators (e.g., gas tank regulator 142, secondary regulator 144, regulator 146). The liquid beverage supply 130 may regulate the pressure of the liquids without using a liquid metering pump assembly 160. The flow rate of the concentrated liquid beverage product from the concentrated liquid beverage supply 134 may be regulated using the secondary regulator 144. A regulator 146 (e.g., a water regulator) may be disposed between filtration unit 136 and the liquid line union 170. Instead of pumps, regulators may control the mix of water from water supply 132 and concentrated liquid beverage product from the concentrated liquid beverage supply 134. The pressure of the concentrated liquid beverage supply 134 may be controlled using secondary regulator 144 and the pressure of the water supply 132 may be controlled using regulator 146. The liquids from the concentrated liquid beverage supply 134 and the water supply 132 may flow into the liquid line union 170 (e.g., without flowing through a liquid metering pump assembly 160). The processing device 190 may control one or more of the gas tank regulator 142, the secondary regulator 144, or the regulator 146.

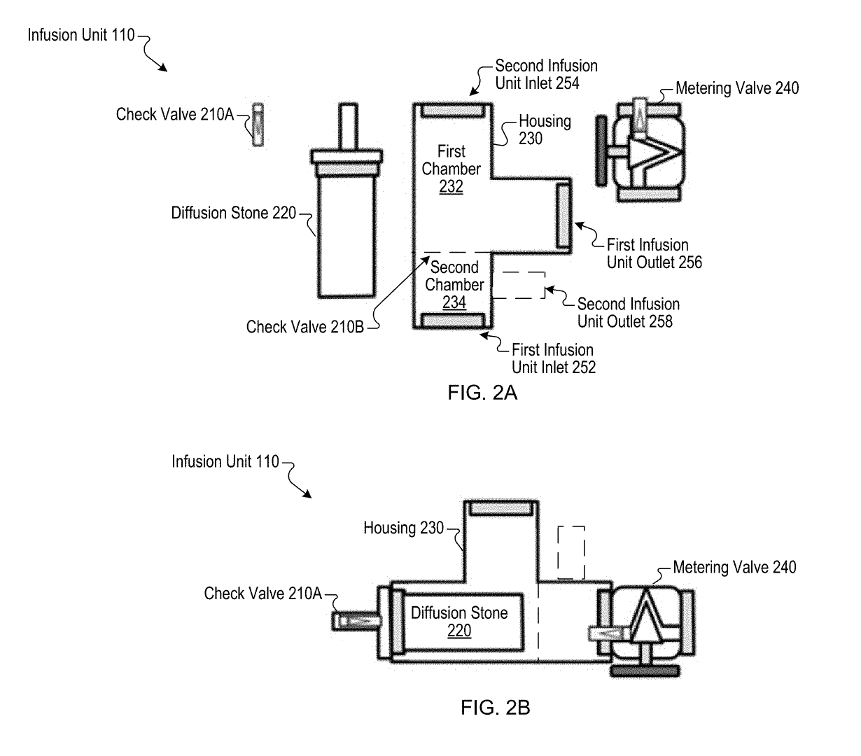

FIGS. 2A-B illustrate an infusion unit 110 of the beverage dispensing system 100, according to one embodiment.

FIG. 2A illustrates components of the infusion unit 110. The infusion unit 110 may include one or more of a check valve 210A (e.g., gas check valve), a diffusion stone 220 (e.g., diffusion cartridge), a housing 230 (e.g., manifold), and a metering valve 240 (e.g., single direction liquid needle valve).

The housing 230 may include a first infusion unit inlet 252, a second infusion unit inlet 254, and a first infusion unit outlet 256. In some embodiments, the housing 230 may include a second infusion unit outlet 258. The housing 230 may form a first chamber 232 and a second chamber 234. In some embodiments, a check valve 210B (e.g., liquid check valve) may be disposed in the housing 230 between the first chamber 232 and the second chamber 234. The check valve 210B may allow fluids to enter the first chamber 232 from the second chamber 234 and may not allow fluids to enter the second chamber 234 from the first chamber 232.

The first infusion unit inlet 252 may be fluidly coupled to the liquid line union 170 to receive liquid beverage product. The second infusion unit inlet 254 may be fluidly coupled to the gas supply to receive gas. The first infusion unit outlet 256 may be fluidly coupled to the dispensing station 120 via the gas-infused liquid beverage line 152 to provide gas-infused liquid beverage product to the dispensing station 120. The second infusion unit outlet 258 may be fluidly coupled to the dispensing station 120 via the liquid beverage line 154B to provide liquid beverage product to the dispensing station 120.

FIG. 2B illustrates an assembled infusion unit 110. The diffusion stone 220 may be partially disposed in the first chamber 232. The check valve 210A is coupled to the second infusion unit inlet 254 to allow gas into the first chamber 232 without letting fluid from the first chamber 232 back through the check valve 210A. In some embodiments, the check valve 210A is fluidly coupled to the diffusion stone 220. The metering valve 240 may be fluidly coupled to the first infusion unit inlet 252 to control rate of infusion of the liquid beverage product into the second chamber 234.

The second chamber 234 formed by the housing 230 may receive liquid beverage product via the first infusion unit inlet 252. Responsive to opening of a valve of the dispensing station 120 coupled to the gas-infused liquid beverage line 152, liquid in the first chamber 232 will exit the housing 230 via the first infusion unit outlet 256, liquid from the second chamber 234 will flow into the first chamber 232 (e.g., causing liquid to flow into the second chamber 234 via the first infusion unit inlet 252, causing the liquid metering pump assembly 160 to activate). Gas (e.g., from the gas supply entering via the second infusion unit inlet 254) will be infused via the diffusion stone 220 into the liquid entering from the second chamber 234 into the first chamber. Responsive to opening of a valve of the dispensing station 120 coupled to the liquid beverage line 154B, liquid in the second chamber 234 will exit the housing 230 via the second infusion unit outlet 258, and liquid will flow into the second chamber 234 via the first infusion unit inlet 252 (e.g., causing the liquid metering pump assembly 160 to activate).

The liquid metering pump assembly 160 may be coupled to a pressure sensor to sense the pressure of the liquid (e.g., liquid beverage product, gas-infused liquid beverage product, the water and concentrated liquid beverage product) in the beverage dispensing system 100. In response to the pressure of the liquid below a threshold pressure, the liquid metering pump assembly 160 may activate to increase the pressure of the liquid in the beverage dispensing system 100.

The diffusion stone 220 may be disposed in the first chamber 232 and liquid beverage product (e.g., pressurized ready-to-drink liquid) may flow through the first infusion unit inlet 252, metering valve 240, second chamber 234, and check valve 210B into the first chamber 232. Pressurized gas may be introduced via the diffusion stone 220 into the pressurized liquid beverage product. Rates of infusion may be set by the difference in pressure between the liquid beverage product (e.g., the ready-to-drink liquid positive pressure) in the first chamber 232 and gas in the diffusion stone 220 (e.g., the gas tank regulator providing gas pressurizing the diffusion stone 220). Pressure differentials may be set via settings of gas tank regulator 142 and the liquid metering pump assembly 160. The gas tank regulator 142 may control pressure of the gas within the diffusion stone 220 and the liquid metering pump assembly 160 may control the pressure of the pressurized liquid being fed into the infusion unit 110. Pressure differential may be used for controlling infusion rates of the gas into the liquid beverage product. In some embodiments, the pressure differential may be monitored using a manometer attached between the gas tank regulator 142 and the liquid line union 170.

Rates of infusion of the gas into the liquid beverage product may also be set by the use of one or more components to restrict flow between the pressurized liquid beverage product (e.g., ready-to-drink beverage) and the diffusion stone 220. Restriction of flow may be achieved by a metering valve 240 that can be set and fixed or freely adjusted. Restriction of flow may be achieved by a fixed or changeable restrictive orifice.

Flow rate between the infusion unit 110 and the dispensing station 120 may be controlled by size of orifices. The orifices may be adjustable or fixed between the infusion unit 110 and the dispensing station 120.

The dispensing station 120 may provide one or more gas-liquid infusion rates. One or more valves of the dispensing station 120 may have a range of flow from the valve being partially open to the valve being fully opened. The one or more valves may produce a range of ready-to-drink gas-infused liquid beverage products (e.g., responsive to pressure balances and flow rates being set to particular gas-liquid infusions). The ratio of the gas to liquid beverage product may be determined by the flow allowance of the dispensing station 120 over the total time beverage is dispensed by the user. Restriction of flow from valving (e.g., metering valve 240), openings, tubing, and/or orifices, sets maximum velocity flow rate of the liquid before the diffusion stone 220.

As a valve of dispensing station 120 opens, a reduction in pressure between the infusion unit 110 and dispensing station 120 is created and allows the pressurized gas to flow into the diffusion stone 220 and the pressurized liquid to flow into the infusion unit 110. The pressurized gas flow through the diffusion stone 220 into the pressurized liquid in the infusion unit 110.

As a valve of the dispensing station 120 is actuated and the surface area of the valving orifices becomes fully exposed, a terminal liquid flow velocity is reached by restriction at the metering valve 240 on entry of infusion unit 110. When terminal velocity of the liquid beverage product entering the infusion unit 110 is reached, gas diffusion rates increase, creating higher concentrations of gas in the gas-infused liquid beverage product.

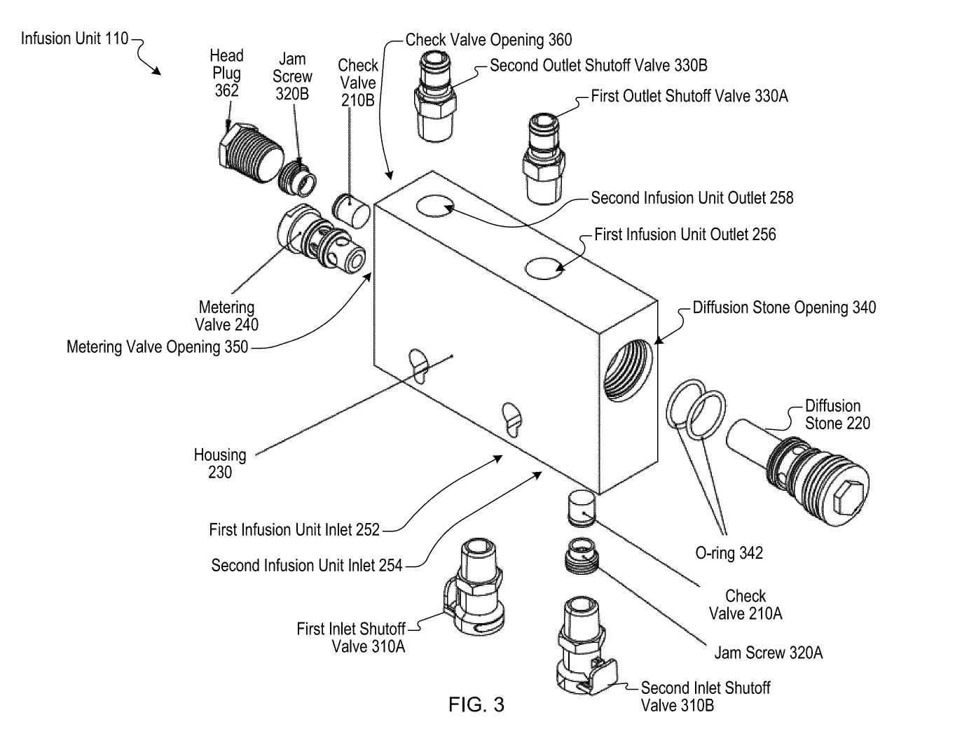

FIG. 3 illustrates an exploded view of an infusion unit 110 of the beverage dispensing system 100, according to one embodiment. Features in FIG. 3 with the same or similar reference numbers as those in FIGS. 1A-2B may have the same or similar functionalities as those in FIGS. 1A-2B.

Infusion unit 110 may include a housing 230 that includes a first infusion unit inlet 252 (on bottom of the housing 230), a second infusion unit inlet 254 (on bottom of the housing 230), a first infusion unit outlet 256, and a second infusion unit outlet 258. A first inlet shutoff valve 310A may be at least partially inserted into the housing 230 through first infusion unit inlet 252. A check valve 210A (e.g., gas check valve), a jam screw 320A (e.g., a jam screw with shoulder), and a second inlet shutoff valve 310B may be at least partially inserted into the housing 230 through second infusion unit inlet 254. A first outlet shutoff valve 330A may be at least partially inserted into first infusion unit outlet 256 and a second outlet shutoff valve 330B may be at least partially inserted into second infusion unit outlet 258.

First inlet shutoff valve 310A may be fluidly coupled to the outlet of the liquid line union 170 to receive liquid beverage product. Second inlet shutoff valve 310B may be fluidly coupled to the gas supply 140 to receive gas. First outlet shutoff valve 330A may be fluidly coupled to the dispensing station 120 via gas-infused liquid beverage line 152 to provide gas-infused liquid beverage product. Second outlet shutoff valve 330B may be fluidly coupled to the dispensing station 120 via liquid beverage line 154B to provide liquid beverage product.

The housing 230 may include a diffusion stone opening 340. One or more O-rings 342 and the diffusion stone 220 may be at least partially inserted into the diffusion stone opening 340.

The housing 230 may include a metering valve opening 350. The metering valve 240 may be at least partially inserted into the housing through metering valve opening 350.

The housing 230 may include a check valve opening 360. The check valve 210B, a jam screw 320B (e.g., a jam screw with shoulder), and a head plug 362 may be at least partially inserted in the housing 230 through check valve opening 360.

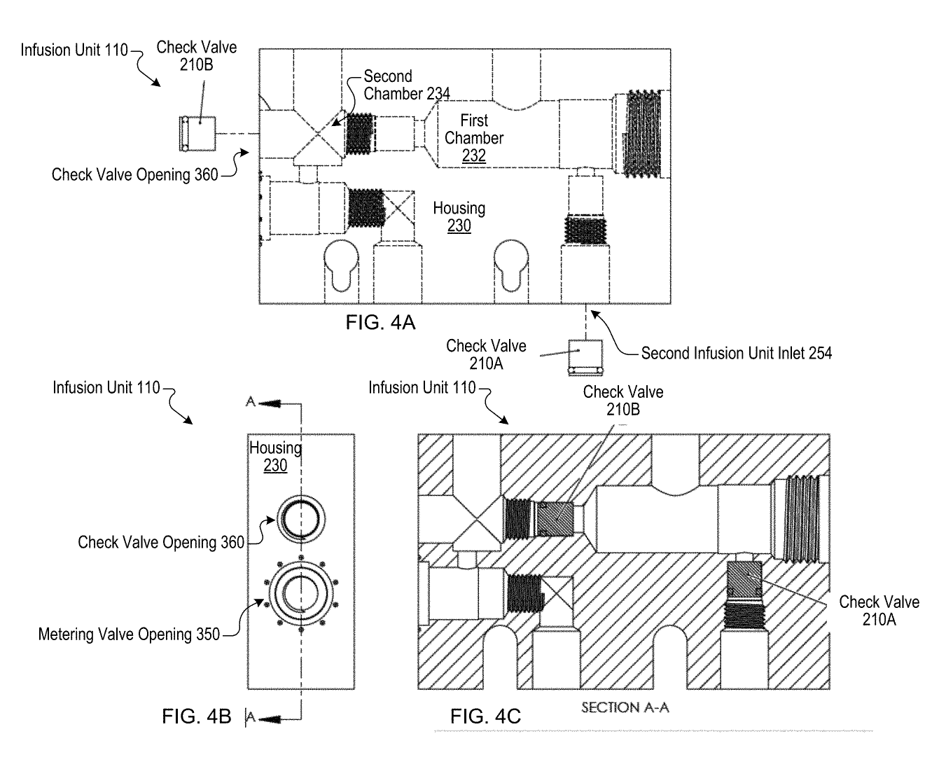

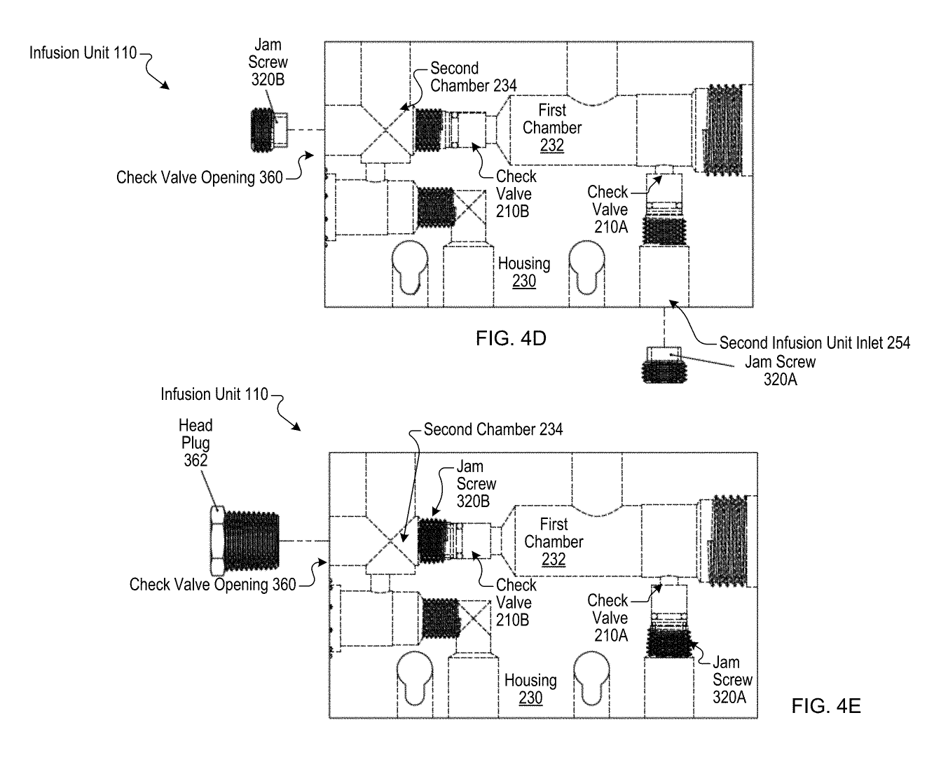

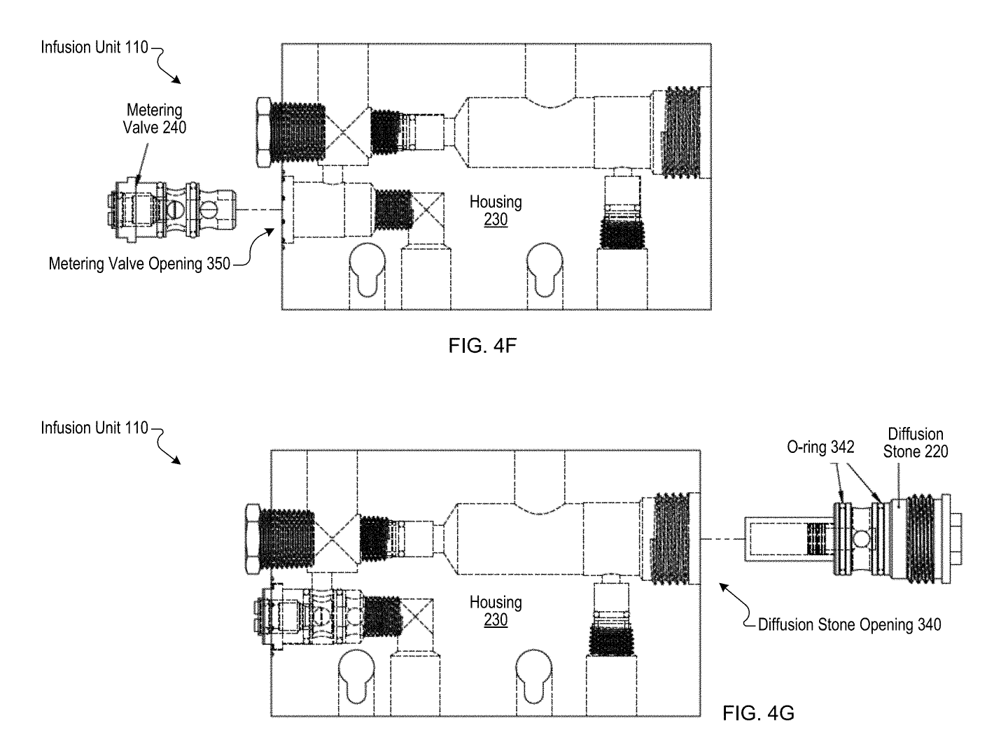

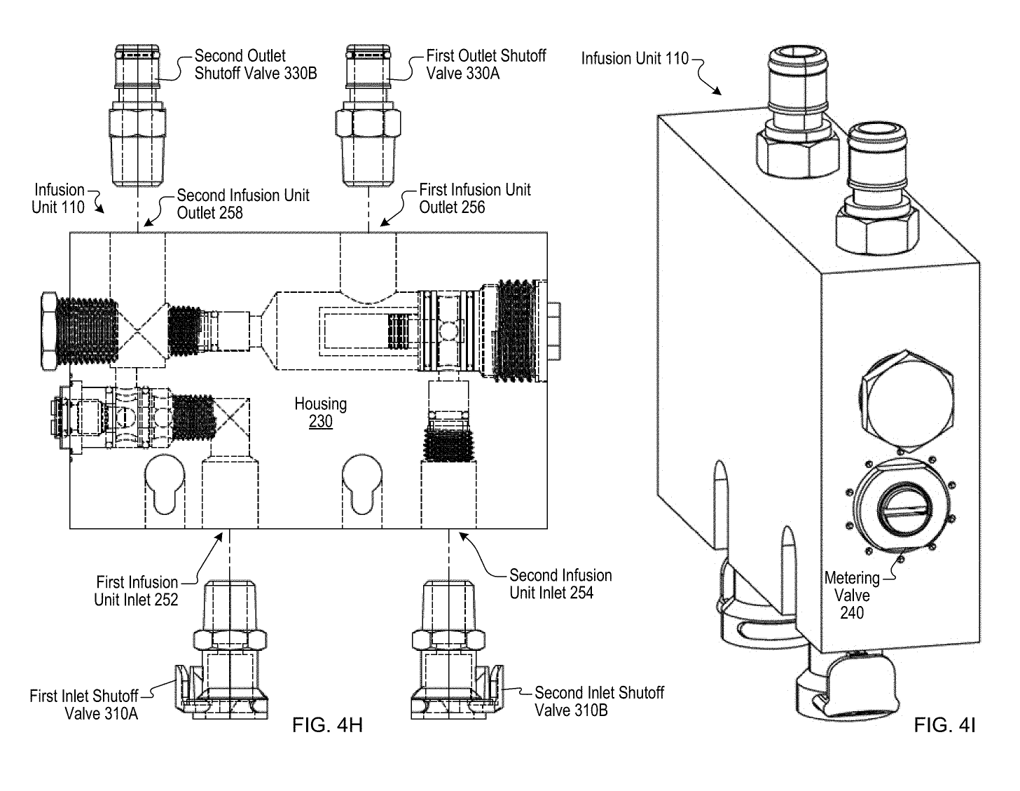

FIGS. 4A-I illustrate assembling an infusion unit 110 of the beverage dispensing system 100, according to one embodiment.

FIGS. 4A-C illustrate inserting of the check valves 210 into the housing 230. Each check valve 210 may have a groove around a circumference of the check valve 210 proximate a first distal end of the check valve 210. An O-ring may be placed within the groove around the circumference of the check valve 210. Check valve 210A may be inserted into the second infusion unit inlet 254 until a second distal end (e.g., opposite the first distal end that is proximate the O-ring) of the check valve 210A is disposed against a seating surface as shown in FIG. 4C. Check valve 210A may allow fluid (e.g., gas) to flow from the second infusion unit inlet 254 to the first chamber 232 without letting fluid flow from the first chamber 232 into the second infusion unit inlet 254.

Check valve 210B may be inserted into the check valve opening 360 until a second distal end (e.g., opposite the first distal end that is proximate the O-ring) of the check valve 210B is disposed against a seating surface as shown in FIG. 4C. The check valve 210B may be disposed between the second chamber 234 and the first chamber 232. Check valve 210B may allow fluid (e.g., liquid beverage product) to flow from the second chamber 234 to the first chamber 232 without letting fluid flow from the first chamber 232 into the second chamber 234.

FIG. 4D illustrates inserting of the jam screws 320 into the housing 230. Jam screw 320A may be inserted into the second infusion unit inlet 254. The jam screw 320A may be threaded into the housing 230 unit the jam screw 320A makes contact with the first distal end of the check valve 210A. The jam screw 320A may be screwed into the housing 230 finger tight. Jam screw 320B may be inserted into the check valve opening 360. The jam screw 320B may be threaded into the housing 230 unit the jam screw 320B makes contact with the first distal end of the check valve 210B. The jam screw 320B may be screwed into the housing 230 finger tight. The jam screws 320 may secure the check valves 210 against the corresponding seating surfaces.

FIG. 4E illustrates inserting the head plug 362 (e.g., cover plug) into the housing 230. Thread seal tape may be wound around the threads of the head plug 362 to create a seal between the head plug 362 and the housing 230. The head plug 362 (e.g., wound with the thread seal tape) may be threaded into the housing 230 at the check valve opening 360. The second chamber 234 may be between the head plug 362 and the check valve 210B.

FIG. 4F illustrates inserting the metering valve 240 into the housing 230. The metering valve 240 may be threaded into the housing at the metering valve opening 350 until it makes contact with the outer face of the housing 230.

FIG. 4G illustrates inserting of the diffusion stone 220 into the housing 230. O-rings 342 may be assembled into grooves (e.g., glands) on the head of the diffusion stone 220. The diffusion stone 220 and O-rings 342 may be thread into the housing 230 until the diffusion stone 220 reaches a hard stop (e.g., the outer surface of the diffusion stone 220 is approximately flush with the outer surface of the housing 230).

FIG. 4H illustrates inserting the shutoff valves 310 and 330 into the housing 230. The threads of the shutoff valves 310 and 330 may be wrapped with thread seal tape prior to the shutoff valves 310 and 330 being thread into the housing 230 to create a seal. The first inlet shutoff valve 310A may be thread into the first infusion unit inlet 252. The second inlet shutoff valve 310B may be thread into the second infusion unit inlet 254. The first outlet shutoff valve 330A may be thread into the first infusion unit outlet 256. The second outlet shutoff valve 330B may be thread into the second infusion unit outlet 258.

FIG. 41 illustrates calibrating the infusion unit 110. The metering valve 240 may be adjusted to calibrate the flow of the liquid beverage product through the infusion unit 110. For example, a flat head screwdriver may be used to turn a valve adjustment interface of the metering valve 240 clockwise to close the metering valve 240 completely. From completely closed, the valve adjustment interface may be turned counterclockwise a threshold amount of turns (e.g., six full turns) to reach baseline. Minor adjustments may be made from this position based on evaluating the flow properties. For example, the valve adjustment interface may be turned clockwise to decrease the flow rate and the valve adjustment interface may be turned counterclockwise to increase the flow rate.

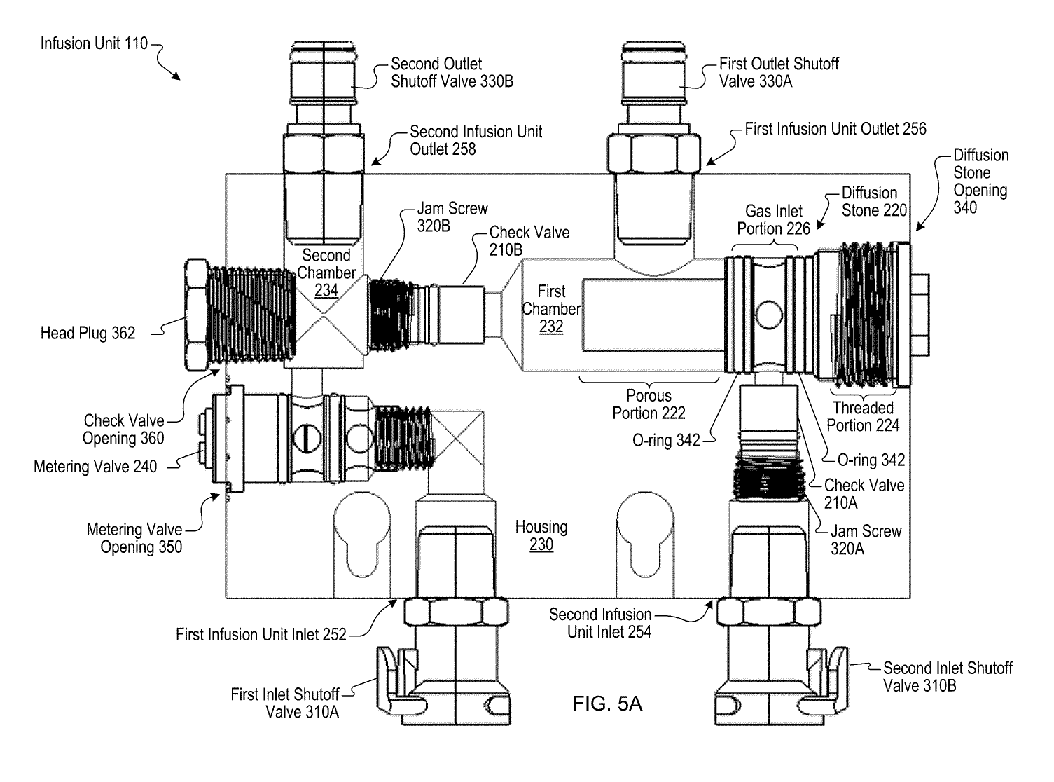

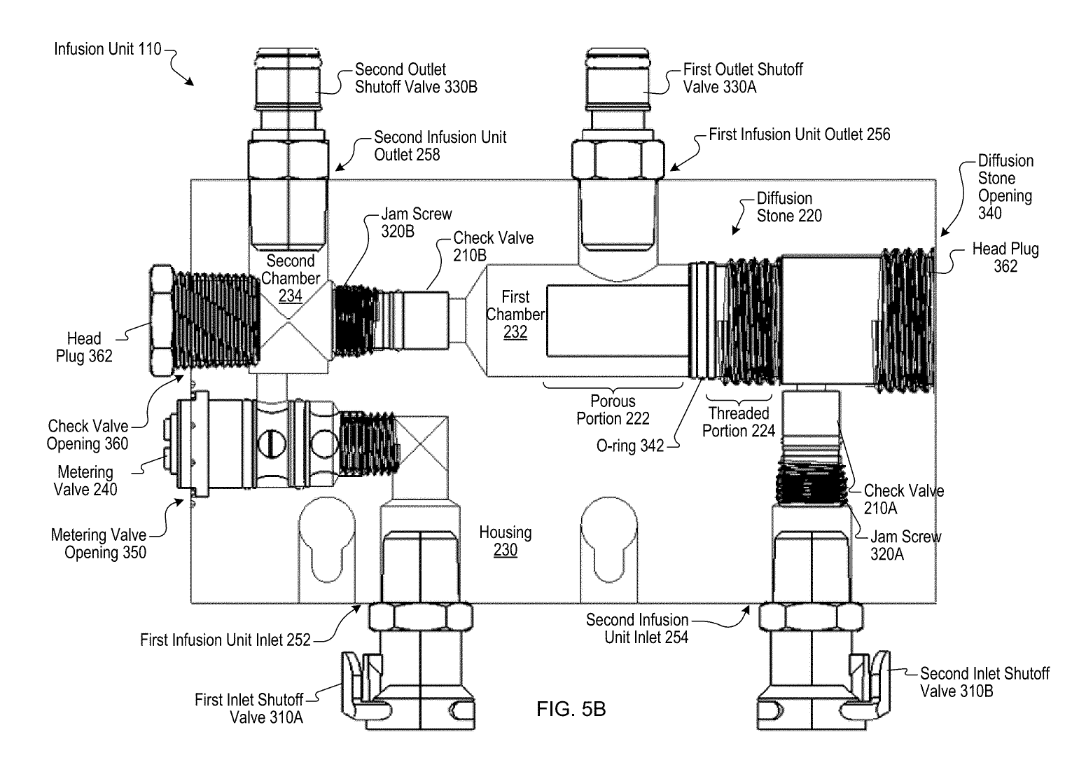

FIG. 5A illustrates an assembled view of an infusion unit 110 of the beverage dispensing system 100, according to one embodiment. The housing 230 is illustrated in a wireframe view in order to see the components disposed inside the housing 230.

Liquid beverage product may flow through the first inlet shutoff valve 310A (e.g., responsive to the first inlet shutoff valve 310A being in an open position) and into the first infusion unit inlet 252. The liquid beverage product may be at a first pressure (e.g., at a first flow rate) based on the pressure exerted by the liquid metering pump assembly 160. From the first infusion unit inlet 252, the liquid beverage product may flow through the metering valve 240 into the second chamber 234. The metering valve 240 may decrease the pressure of the liquid beverage product to a second pressure that is lower than the first pressure, but that is still greater than atmospheric pressure. Responsive to the dispensing station 120 dispensing liquid beverage product, the liquid beverage product from the second chamber 234 may flow through the second infusion unit outlet and through the second outlet shutoff valve 330B to the dispensing station 120 via the liquid beverage line 154B.

Gas may flow through the second inlet shutoff valve 310B (e.g., responsive to the second inlet shutoff valve 310B being in an open position) and into the second infusion unit inlet 254. The gas may flow through the hollow jam screw 320A and through the check valve 210A into the diffusion stone 220. Responsive to the dispensing station 120 dispensing gas-infused liquid beverage product, the liquid beverage product from the second chamber 234 may flow through the hollow jam screw 320B and through the check valve 210B into the first chamber. Gas may also flow through the diffusion stone 220 (e.g., via pores in the diffusion stone 220) to infuse into the liquid beverage product in the first chamber to produce a gas-infused liquid beverage product. The gas-infused liquid beverage product may flow through the first infusion unit outlet 256 and through the first outlet shutoff valve 330A to the dispensing station 120 via the gas-infused liquid beverage line 152.

The diffusion stone 220 may include a porous portion 222 at a first distal end, a threaded portion 224 at a second distal end, and a gas-inlet portion 226 between the porous portion 222 and the threaded portion.

The diffusion stone 220 may enter the housing 230 via the diffusion stone opening 340 and the threaded portion 224 may engage with the housing 230 at the diffusion stone opening 340. The diffusion stone 220 may be accessible from exterior of the housing 230 via the threaded portion 224 (e.g., the threaded portion 226 may have a head for tightening the diffusion stone 220 into the housing 230).

The diffusion stone 220 may be cylindrical. The gas-inlet portion 226 may be hollow and may form a first internal chamber. The porous portion 222 may be hollow and may form a second internal chamber. The porous portion 222 and the gas-inlet portion 226 may be coupled so that the first internal chamber is fluidly coupled with the second internal chamber.

The gas-inlet portion 226 may form one or more openings to allow gas to flow from outside of the gas-inlet portion 226, through the one or more openings, and into the first internal chamber. For example, gas may flow through the second inlet shutoff valve 310B, through the jam screw 320A, through the check valve 210, and through the openings of gas-inlet portion 226 into the first internal chamber. The gas may flow from the first internal chamber into the second internal chamber. The porous portion 222 may form pores to allow the gas to flow from the second internal chamber, through the pores, and into the liquid beverage product in the first chamber 232.

The gas-inlet portion 226 may form one or more grooves on the exterior circumference of the gas-inlet portion 226. One or more O-rings 342 may be disposed in the one or more grooves. In one embodiment, the gas-inlet portion 226 may include a first groove and a second groove. The one or more openings to the first internal chamber may be formed between the first groove and the second groove. A first O-ring 342 may be disposed in the first groove and a second O-ring 342 may be disposed in the second groove (e.g., to form a dual O-ring seal). The O-rings 342 may seal the gas-inlet portion 226 so that gas does not flow from the gas-inlet portion 226 to the first chamber 232 without flowing through the porous portion 222 and so that gas does not flow out the diffusion stone opening 340 via the threaded portion 224.

The porous portion 222 may have a closed end at the first distal end. The closed end of the porous portion 222 may form pores and may allow gas through the pores of the closed end.

In some embodiments, the porous portion 222, the gas-inlet portion 226, and the threaded portion 224 are made from the same material. In some embodiments, one or more of the porous portion, the gas-inlet portion 226, and the threaded portion 224 are different components (e.g., are removably attached to each other). In some embodiments, one or more of the porous portion, the gas-inlet portion 226, and the threaded portion 224 are made of different materials than each other.

The porous portion 222 may be stainless steel. In some embodiments, porous portion 222 may be a marine grade stainless alloy. In some embodiments, porous portion 222 is a molybdenum-alloyed steel. For example, porous portion 222 may be a Society of Automotive Engineers (SAE) 316 stainless steel. In some embodiments, the porous portion 222 may form 0.5-micron openings to allow gas to flow from the second internal chamber to the first chamber 232 (e.g., the diffusion stone 220 may be a 0.5-micron diffusion stone). In some embodiments, the porous portion 222 may form 2-micron openings to allow gas to flow from the second internal chamber to the first chamber 232 (e.g., the diffusion stone 220 may be a 2-micron diffusion stone). The porous portion 222 may have about a 0.5-inch diameter and about a one-inch length.

Liquid beverage product in the first chamber 232 may be at a first pressure and gas in the porous portion 222 may be at a second pressure that is greater than the first pressure. Gas at the second pressure may push through the pores of the porous portion 222 of the diffusion stone 220 to dissolve the gas in the liquid beverage product. The gas may exit the pores of the porous portion 222 as bubbles. The bubbles may give more surface area to the gas for diffusion. The absorption rate of the gas into the liquid beverage product may be rapid responsive to the surface area contact between the gas and liquid beverage product.

FIG. 5B illustrates an assembled view of an infusion unit 110 of the beverage dispensing system 100, according to another embodiment. The housing 230 is illustrated in a wireframe view in order to see the components disposed inside the housing 230. Elements in FIG. 5B that have a similar reference number as elements in FIG. 5A may include similar features and similar functionality as the elements described in relation to FIG. 5A.

In FIG. 5B, threaded portion 224 may be hollow and may provide a third internal chamber. The second internal chamber formed by the porous portion 222 may be fluidly coupled with the third internal chamber formed by the threaded portion 224.

The diffusion stone 220 may enter the housing 230 through the diffusion stone opening 340. A threaded portion 224 of the diffusion stone 220 may engage with a first set of threads within the diffusion stone opening 340 in the housing 230. A head plug 362 may engage with a second set of threads within the diffusion stone opening 340 in the housing 230. A groove in the diffusion stone 220 may be disposed between the porous portion 222 and the threaded portion 224. An O-ring 342 may be disposed in the groove to create a seal between the housing 230 and the diffusion stone 220. Gas may flow through the second inlet shutoff valve 310B, through the jam screw 320A, through the check valve 210A, into a portion of the diffusion stone opening 340 between the head plug 362 and the diffusion stone 220, through the third chamber formed by the threaded portion 224, into the second chamber formed by the porous portion 222, and through the pores of the porous portion 222 into the first chamber 232 of the housing 230.

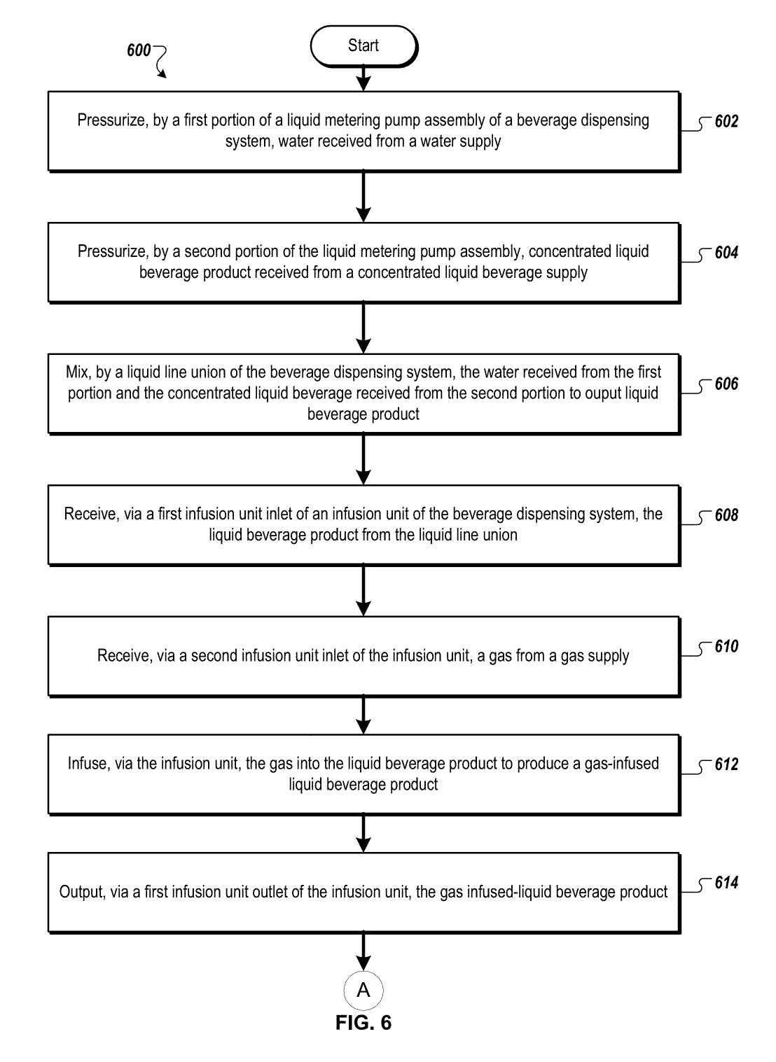

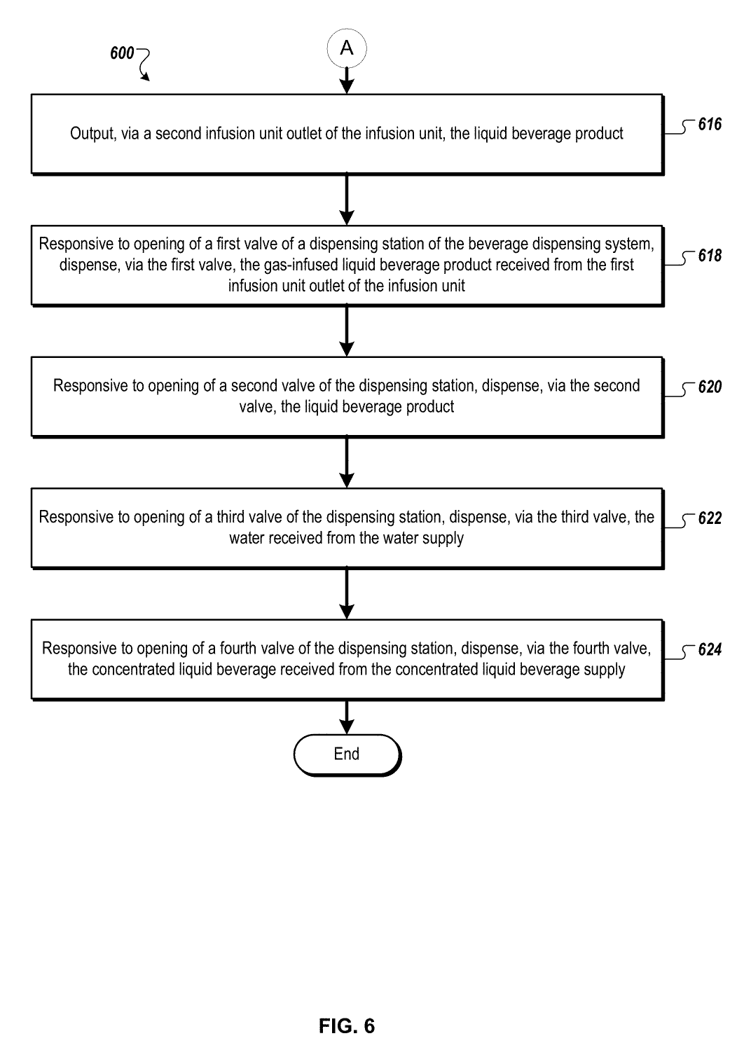

FIG. 6 is a flow diagram of one embodiment of a method 600 of dispensing liquid via a beverage dispensing system 100 in accordance with embodiments of the present disclosure. The method 600 may be performed by a beverage dispensing system 100 of one or more of FIGS. 1A-C. Alternatively, method 600 may be performed by other components as described herein.

Referring to FIG. 6, at block 602, the beverage dispensing system 100 implementing the method 600 may pressurize, by a first portion of a liquid metering pump assembly 160 of the beverage dispensing system 100, water received from a water supply 132.

At block 604, the beverage dispensing system 100 may pressurize, by a second portion of the liquid metering pump assembly 160, concentrated liquid beverage product received from a concentrated liquid beverage supply 134.

At block 606, the beverage dispensing system 100 may mix, via a liquid line union 170, water received from the first portion of the liquid metering pump assembly 160 and the concentrated liquid beverage product received from the second portion of the liquid metering pump assembly 160 to output a liquid beverage product.

At block 608, the beverage dispensing system 100 may receive, via a first infusion unit inlet 252 of an infusion unit 110 of the beverage dispensing system 100, a liquid beverage product from the liquid line union 170.

At block 610, the beverage dispensing system 100 may receive, via a second infusion unit inlet 254 of the infusion unit 110, a gas from a gas supply 140. The gas may be received via a gas tank regulator 142.

At block 612, the beverage dispensing system 100 may infuse, via the infusion unit 110, the gas into the liquid beverage product to produce a gas-infused liquid beverage product. The infusion unit 110 may infuse the gas into the liquid beverage product via a diffusion stone 220 of the infusion unit 110. The diffusion stone 220 may receive the gas via the second infusion unit inlet 254 and the diffusion stone 220 may output the gas into the liquid beverage product in the infusion unit 110 via pores in the diffusion stone 220. In one example, the pores are 2-micron pores. In another example, the pores are 0.5-micron pores. The gas in the diffusion stone 220 may be at a higher pressure than the liquid beverage product surrounding the diffusion stone 220.

At block 614, the beverage dispensing system 100 may output, via a first infusion unit outlet 256 of the infusion unit 110, the gas-infused liquid beverage product.

At block 616, the beverage dispensing system 100 may output, via a second infusion unit outlet 258 of the infusion unit 110, the liquid beverage product.

At block 618, the beverage dispensing system 100 may, responsive to opening of a first valve of a dispensing station 120 of the beverage dispensing system 100, dispense, via the first valve, the gas-infused liquid beverage product received from a first infusion unit outlet 256 of the infusion unit 110.

At block 620, the beverage dispensing system 100 may, responsive to opening of a second valve of the dispensing station 120, dispense, via the second valve, the liquid beverage product. In one embodiment, the second valve receives the liquid beverage product from a first infusion unit outlet 256 of the infusion unit 110. In another embodiment, the second valve receives the liquid beverage product from the outlet of the liquid line union 170.

At block 622, the beverage dispensing system 100 may, responsive to opening of a third valve of a dispensing station 120 of the beverage dispensing system 100, dispense, via the third valve, the water. In some embodiments, the water is received from the water supply 132. In some embodiments, the water is received from the first portion 162A of the liquid metering pump assembly 160.

At block 624, the beverage dispensing system 100 may, responsive to opening of a fourth valve of a dispensing station 120 of the beverage dispensing system 100, dispense, via the fourth valve, the concentrated liquid beverage product. In some embodiments, the concentrated liquid beverage product is received from the concentrated liquid beverage supply 134. In some embodiments, the concentrated liquid beverage product is received from the second portion 162B of the liquid metering pump assembly 160.

The beverage dispensing system 100 may control components of the beverage dispensing system 100 via a processing device 190.

FIG. 7 is a flow diagram of one embodiment of a method 700 of dispensing liquid from a beverage dispensing system 100, in accordance with embodiments of the present disclosure. The method 700 may be performed by processing logic that includes hardware (e.g., circuitry, dedicated logic, programmable logic, microcode, etc.), software (e.g., instructions run on a processor to perform hardware simulation), or a combination thereof. In one embodiment, the method 700 may be performed by beverage dispensing system 100 of FIG. 1A and/or FIG. 1B. In one embodiment, the method 700 may be performed by control box 192 of FIG. 1A and/or FIG. 1B. In one embodiment, the method 700 may be performed by processing device 190 of FIG. 1A and/or FIG. 1B. Alternatively, the method 700 can be performed by other components as described herein.

Referring to FIG. 7, at block 702, the processing device 190 implementing the method 700 may control the liquid metering pump assembly 160 to provide water at a first pressure and concentrated liquid beverage product at a second pressure. In some embodiments, the processing device 190 may control a first portion 162A of the liquid metering pump assembly 160 to provide the water at the first pressure and may control a second portion 162B of the liquid metering pump assembly 160 to provide the concentrated liquid beverage product at a second pressure. The processing device 190 may control the first portion 162A and the second portion 162B independent of each other. In some embodiments, the processing device 190 may control the regulator 146 to provide the water at the first pressure and may control the secondary regulator 144 to provide the concentrated liquid beverage product at a second pressure (e.g., without using a liquid metering pump assembly 160).

At block 704, the processing device 190 may control the gas tank regulator 142 to provide gas at a third pressure.

At block 706, the processing device 190 may control the infusion unit 110 (e.g., control the metering valve 240 of the infusion unit 110) to control the flow rate of liquid beverage product within the infusion unit 110. In some embodiments, the processing device 190 may control the flow restriction orifice 172 to control the pressure of the liquid beverage product (e.g., in the liquid beverage line 154A).

At block 708, the processing device 190 may receive user input to control at least one of concentration or gas level of a beverage dispensed by the dispensing station 120. The processing device 190 may be coupled to a user interface (e.g., integrated into the dispensing station 120, displayed on a computing device external to the dispensing station 120, displayed via a mobile device, etc.) and may receive the user input via the user interface.

At block 708, the processing device 190 may control one or more valves of the dispensing station 120 to dispense the beverage based on the user input.

In one embodiment, the processing device 190 may receive user input to change the amount of gas in the beverage dispensed by the dispensing station 120. The processing device 190 may control the valve of the dispensing station 120 that is coupled to the liquid beverage line 154 and the valve of the dispensing station 120 that is coupled to the gas-infused liquid beverage line 152 to adjust the amount of gas in the liquid dispensed by the dispensing station 120. For example, in response to receiving user input of 70% full capability of gas-infusion, the processing device 190 may cause the valve coupled to the gas-infused liquid beverage line 152 to open 70% and may cause the valve coupled to the liquid infused beverage line 154 to open 30% (e.g., the two valves may be opened simultaneously).

In another embodiment, the processing device 190 may receive user input to change the level of concentration of the beverage dispensed by the dispensing station 120. The processing device 190 may control two or more of the valve of the dispensing station 120 that is coupled to the liquid beverage line 154, the valve of the dispensing station 120 that is coupled to the concentrated liquid beverage line 158, or the valve of the dispensing station 120 that is coupled to the water line 156 to adjust the level of concentration of the liquid dispensed by the dispensing station 120. For example, in response to receiving user input of 25% concentration, the processing device 190 may cause the valve coupled to the gas-infused liquid beverage line 152 to open 25% and may cause the valve coupled to the water line 156 to open 75%. In another example, in response to receiving user input of 300% concentration, the processing device may cause the valve coupled to the gas-infused liquid beverage line 152 to open 50% and may cause the valve coupled to the concentrated liquid beverage line 158 to open 50%.

In another embodiment, the processing device 190 may receive user input to change the concentration and the gas level of the beverage dispensed by the dispensing station 120. The processing device 190 may control three or more of the valves of the dispensing station 120. For example, in response to receiving user input of 50% concentration and 25% full capability of gas-infusion, the processing device 190 may cause the valve coupled to the gas-infused liquid beverage line 152 to open 25%, the valve coupled to the liquid beverage line 154 to open 25%, and may cause the valve coupled to the water line 156 to open 50%.

In some embodiments, the processing device 190 may control the amount of gas, concentrated liquid product, and water after the gas is infused in the liquid beverage product in the infusion unit 110. For example, the processing device may open and close valves of the dispensing station 120 after the infusion of gas in liquid beverage product in the infusion unit 110.

In some embodiments, the processing device 190 may control the amount of gas, concentrated liquid product, and water before the gas is infused in the liquid beverage product in the infusion unit 110. For example, the processing device 190 may control the gas tank regulator 142 and liquid metering pump assembly to provide amounts of gas, water, and concentrated liquid beverage product prior to the infusion of gas in the liquid beverage product in the infusion unit 110.

In some embodiments, the processing device 190 may control the amount of gas, concentrated liquid product, and water both before and after the gas is infused in the liquid beverage product in the infusion unit 110.

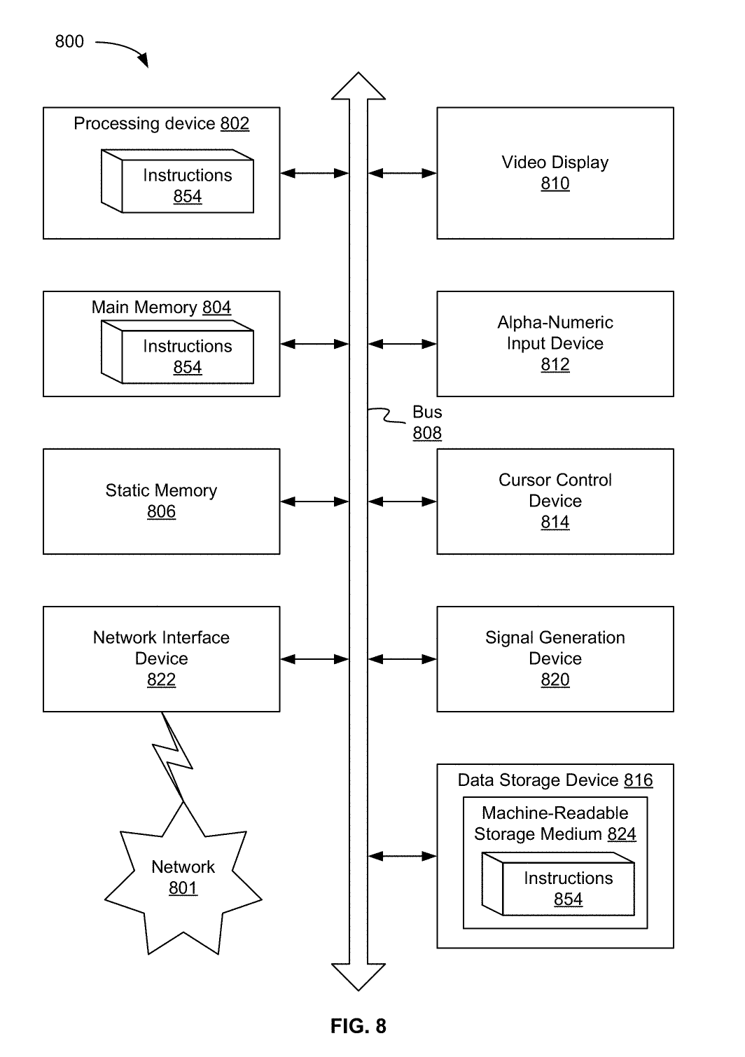

FIG. 8 illustrates a component diagram of a computer system which may implement one or more methods of dispensing liquid via a beverage dispensing system 100 described herein. A set of instructions for causing the computer system 800 to perform any one or more of the methods discussed herein may be executed by the computer system 800. In one embodiment, the computer system 800 may implement the functions of the processing device 190 and/or control box 192 of FIG. 1A and/or FIG. 1B.

In one embodiment, the computer system 800 may be connected to other computer systems by a network 801 provided by a Local Area Network (LAN), an intranet, an extranet, the Internet or any combination thereof. The computer system may operate in the capacity of a server or a client machine in a client-server network environment or as a peer machine in a peer-to-peer (or distributed) network environment. The computer system may be a personal computer (PC), a tablet PC, a set-top box (STB), a Personal Digital Assistant (PDA), a cellular telephone, a web appliance, a server, a network router, switch, bridge or any machine capable of executing a set of instructions (sequential or otherwise) that specify actions to be taken by that machine. Further, while a single machine is illustrated, the term “computer system” shall also be taken to include any collection of machines (e.g., computers) that individually or jointly execute a set (or multiple sets) of instructions to perform any one or more of the methodologies discussed herein.

In one embodiment, the computer system 800 includes a processing device 802, a main memory 804 (e.g., read-only memory (ROM), flash memory, dynamic random access memory (DRAM) such as synchronous DRAM (SDRAM), etc.), a static memory 806 (e.g., flash memory, static random access memory (SRAM), etc.) and a data storage device 816, which communicate with each other via a bus 808.

In one embodiment, the processing device 802 represents one or more general-purpose processors such as a microprocessor, central processing unit or the like. Processing device may include any combination of one or more integrated circuits and/or packages that may, in turn, include one or more processors (e.g., one or more processor cores). Therefore, the term processing device encompasses a single core CPU, a multi-core CPU and a massively multi-core system that includes many interconnected integrated circuits, each of which may include multiple processor cores. The processing device 802 may therefore include multiple processors. The processing device 802 may include a complex instruction set computing (CISC) microprocessor, reduced instruction set computing (RISC) microprocessor, very long instruction word (VLIW) microprocessor, processor implementing other instruction sets or processors implementing a combination of instruction sets. The processing device 802 may also be one or more special-purpose processing devices such as an application specific integrated circuit (ASIC), a field programmable gate array (FPGA), a digital signal processor (DSP), network processor or the like.

The processing device 802 may be the processing device 190 (see FIGS. 1A-C). The processing device 802 may include one or more interfaces to connect to one or more of valves of dispensing station 120, sensors, liquid metering pump assembly 160, gas tank regulator 142, secondary regulator 144, regulator 146, flow restriction orifice 172, metering valve 240, etc.

In one embodiment, the computer system 800 may further include one or more network interface devices 822. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse) and a signal generation device 820 (e.g., a speaker).

In one embodiment, the data storage device 816 may include a computer-readable storage medium 824 on which is stored one or more sets of instructions 854 embodying any one or more of the methods or functions described herein. The instructions 854 may also reside, completely or at least partially, within the main memory 804 and/or within the processing device 802 during execution thereof by the computer system 800; the main memory 804 and the processing device 802 also constituting machine-readable storage media. The computer-readable storage medium 824 may be a non-transitory computer-readable storage medium.

While the computer-readable storage medium 824 is shown as a single medium, the term “computer-readable storage medium” should be taken to include a single medium or multiple media (e.g., a centralized or distributed database and associated caches and servers) that store the one or more sets of instructions. The term “computer-readable storage medium” shall also be taken to include any medium that is capable of storing, encoding, or carrying a set of instructions for execution by the machine and that cause the machine to perform any one or more of the methods described herein. Examples of computer-readable storage media include, but not limited to, solid-state memories, optical media and magnetic media.

In the above description, numerous details are set forth. It will be apparent, however, to one of ordinary skill in the art having the benefit of this disclosure, that embodiments may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “outputting,” “pressurizing,” “mixing,” “infusing,” “opening,” “dispensing,” “controlling,” “producing,” “providing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments also relate to an apparatus for performing the operations herein. This apparatus may be specially constructed for the required purposes, or it may include a general-purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the present embodiments are not described with reference to any particular programming language. It will be appreciated that a variety of programming languages may be used to implement the teachings of the present disclosure as described herein. It should also be noted that the terms “when” or the phrase “in response to,” as used herein, should be understood to indicate that there may be intervening time, intervening events, or both before the identified operation is performed.

It is to be understood that the above description is intended to be illustrative, and not restrictive. Many other embodiments will be apparent to those of skill in the art upon reading and understanding the above description. The scope of the present embodiments should, therefore, be determined with reference to the appended claims, along with the full scope of equivalents to which such claims are entitled.

What is claimed is:

1. A beverage dispensing system comprising:
an infusion unit to mix a liquid beverage product and a gas to produce a gas-infused liquid beverage product, the infusion unit comprising:
a first infusion unit inlet to receive the liquid beverage product;
a second infusion unit inlet to receive the gas;
a first infusion unit outlet to output the gas-infused liquid beverage product; and
a dispensing station comprising:
a first valve, coupled to the first outlet of the infusion unit, to receive and dispense the gas-infused liquid beverage product; and
a second valve to receive and dispense the liquid beverage product.

2. The beverage dispensing system of claim 1, wherein the infusion unit further comprises a second infusion unit outlet to output the liquid beverage product, wherein the second valve is coupled to the second outlet of the infusion to receive and dispense the liquid beverage product.

3. The beverage dispensing system of claim 1 further comprising a liquid metering pump assembly, the liquid metering pump assembly comprising:
a first portion of the liquid metering pump assembly to receive water from a water supply and to pressurize the water; and
a second portion of the liquid metering pump assembly to receive concentrated liquid beverage product from a concentrated liquid beverage supply and to pressurize the concentrated liquid beverage product.

4. The beverage dispensing system of claim 3 further comprising a liquid line union to mix the water and the concentrated liquid beverage product to output the liquid beverage product, the liquid line union comprising:
a first union inlet, coupled to the first portion of the liquid metering pump assembly, to receive the water;
a second union inlet, coupled to the second portion of the liquid metering pump, to receive the concentrated liquid beverage product; and
a union outlet to output the liquid beverage product.

5. The beverage dispensing system of claim 1 further comprising a gas tank regulator, coupled to a gas supply and the second infusion unit inlet, to receive the gas from the gas supply and to provide the gas at a first pressure to the second infusion unit inlet.

6. The beverage dispensing system of claim 3, wherein the dispensing station further comprises:
a third valve, coupled to the water supply, to receive and dispense the water; and
a fourth valve, coupled to the concentrated liquid beverage supply, to receive and dispense the concentrated liquid beverage product.

7. The beverage dispensing system of claim 1, wherein the second infusion unit inlet further comprises a diffusion stone to receive the gas from a gas supply via a gas tank regulator and to infuse the gas into the liquid beverage product.

8. An infusion unit of a beverage dispensing system, the infusion unit comprising:
a first infusion unit inlet to receive a liquid beverage product;
a second infusion unit inlet to receive a gas;
a housing forming a first chamber to receive the liquid beverage product from the first infusion unit inlet;
a diffusion stone coupled to the second infusion unit inlet, wherein the diffusion stone extends into the first chamber of the housing to introduce gas into the liquid beverage product to produce a gas-infused liquid beverage product; and
a first infusion unit outlet, coupled to the first chamber of the housing, to output the gas-infused liquid beverage product.

9. The infusion unit of claim 8 further comprising a check valve, wherein the housing further forms a second chamber coupled to the first infusion unit inlet to receive the liquid beverage product, wherein the first chamber of the housing is coupled to the second chamber of the housing via the check valve to receive the liquid beverage product via the check valve from the first infusion unit inlet.

10. The infusion unit of claim 9 further comprising a second infusion unit outlet to receive the liquid beverage product from the second chamber.

11. The infusion unit of claim 8 further comprising a gas check valve, wherein the diffusion stone is to receive the gas via the gas check valve from the second infusion unit inlet.

12. The infusion unit of claim 8, wherein the first inlet further comprises a metering valve to control rate of infusion of the liquid beverage product into the first chamber.

13. The infusion unit of claim 8, wherein the infusion unit is coupled to a dispensing station of the beverage dispensing system, wherein the infusion unit is to provide gas-infused liquid beverage product to the dispensing station via the first infusion unit outlet.

14. The infusion unit of claim 13 further comprising a second infusion unit outlet to receive the liquid beverage product from the first infusion unit inlet, wherein the infusion unit is to provide the liquid beverage product to the dispensing station via the second infusion unit outlet.

15. A method comprising:
receiving, via a first infusion unit inlet of an infusion unit of a beverage dispensing system, a liquid beverage product;
receiving, via a second infusion unit inlet of the infusion unit, a gas;
infusing, by the infusion unit, the gas into the liquid beverage product to produce a gas-infused liquid beverage product;
outputting, via a first infusion unit outlet of the infusion unit, the gas-infused liquid beverage product;
receiving, via a first valve of a dispensing station of the beverage dispensing system from the first infusion unit outlet, the gas-infused liquid beverage product; and
dispensing, via the first valve, the gas-infused liquid beverage product responsive to opening of the first valve.

16. The method of claim 15 further comprising:
outputting, via a second infusion unit outlet of the infusion unit, the liquid beverage product;
receiving, via a second valve of the dispensing station from the second infusion unit outlet, the liquid beverage product; and
dispensing, via the second valve, the liquid beverage product responsive to opening of the second valve.

17. The method of claim 15 further comprising:
pressurizing, by a first portion of the liquid metering pump assembly of the beverage dispensing system, water received from a water supply;
pressurizing, by a second portion of the liquid metering pump assembly, concentrated liquid beverage product received from a concentrated liquid beverage supply; and
mixing, by a liquid line union of the beverage dispensing system, the water received from the first portion of the liquid metering pump assembly and the concentrated liquid beverage product received from the second portion of the liquid metering pump assembly to output liquid beverage product to the first infusion unit inlet.

18. The method of claim 17 further comprising:
receiving, via a third valve of the dispensing station from the water supply, the water;
dispensing, via the third valve, the water responsive to opening of the third valve;
receiving, via a fourth valve of the dispensing station from the concentrated liquid beverage supply, the concentrated liquid beverage product; and
dispensing, via the fourth valve, the concentrated liquid beverage product responsive to opening of the fourth valve.

19. The method of claim 17 further comprising:
receiving, via a second valve of the dispensing station from the liquid line union, the liquid beverage product; and
dispensing, via the second valve, the liquid beverage product responsive to opening of the second valve.

20. The method of claim 15, wherein the infusing of the gas into the liquid beverage product is via a diffusion stone of the infusion unit.
